(19) United States
(12) Patent Application Publication
(10) Pub. No.: US 2005/0234784 A1
(43) Pub. Date: Oct. 20, 2005

(54) Container inventory management

(76) Inventors: Richard L. McClellan, Clinton, IL (US); John F. Less, Forsyth, IL (US)

Correspondence Address: KIRKPATRICK & LOCKHART NICHOLSON GRAHAM LLP, 535 SMITHFIELD STREET, PITTSBURGH, PA, 15222, US

(21) Appl. No.: 10/816,147

(22) Filed: Apr. 1, 2004

(51) Int. Cl. G06F 17/60

(52) U.S. Cl. 705/28; 700/236

(57) ABSTRACT

In various embodiments, an inventory management system is configured for use in association with at least one container containing an amount of inventory material at a monitored location. The inventory management system includes at least one measurement instrument operatively associated with the container, the measurement instrument being configured to generate at least one data signal representative of the amount of the inventory material in the container. The inventory management system also includes a telemetry unit in communication with the measurement instrument, the telemetry unit being configured to receive at least the generated data signal from the measurement instrument and to convert the generated data signal into inventory information. The inventory management system also includes a first server in communication with the telemetry unit, the first server configured to receive at least the inventory information from the telemetry unit; and at least a second server in communication with the first server, the second server configured for receiving at least the inventory information from the first server via an Internet connection, the second server being configured to process the inventory information for presentation on at least one website.

### BACKGROUND

Increasing customer satisfaction while reducing inventory costs is a goal universally strived for in business. To this end, many businesses such as manufacturers, retailers, and wholesalers have attempted to increase their competitive advantage by implementing lean manufacturing strategies that manage the inventory costs of direct and indirect (i.e., raw) material. For example, a company may implement just-in-time inventory systems, wherein a facility, such as a manufacturing plant, maintains a minimal inventory level that triggers suppliers to frequently replenish the inventory with deliveries that are synchronized with the plant's on-hand balances and actual and predicted material needs.

With many just-in-time inventory systems, material shipments may be triggered multiple times a day depending on the cost, size and use of the component or material. To avoid missed shipments that may result in material shortages or unwanted shipments that may result in excess inventory, companies monitor inventory data, such as material consumption rates, and compare this data against the on-hand balances of material located within a company's own facility. However, in an effort to reduce the total cost of a material supply system, it is also desirable for companies not only to track in-house material, but also to compile data that quantifies and describes the inventories located at their customers and/or suppliers and to communicate such data throughout the extended supply chain.

To communicate inventory information throughout the supply chain, conventional inventory systems employ communications equipment that typically require dedicated communication lines and/or complex networking infrastructures. Many conventional systems are often ineffective at communicating inventory information in an understandable and readily useable format. In addition, many businesses are either unwilling or unable to pay the cost of installing and maintaining the expensive, dedicated communications equipment associated with conventional systems for gathering inventory information.

### SUMMARY

Various embodiments of the present invention are directed to an inventory management system. In certain embodiments, an inventory management system is configured for use in association with at least one container containing an amount of inventory material at a monitored location. The inventory management system includes at least one measurement instrument operatively associated with the container, the measurement instrument being configured to generate at least one data signal representative of the amount of the inventory material in the container. The inventory management system also includes a telemetry unit in communication with the measurement instrument, the telemetry unit being configured to receive at least the generated data signal from the measurement instrument and to convert the generated data signal into inventory information. The inventory management system also includes a first server in communication with the telemetry unit, the first server configured to receive at least the inventory information from the telemetry unit, and at least a second server in communication with the first server, the second server configured for receiving at least the inventory information from the first server via an Internet connection, the second server being configured to process the inventory information for presentation on at least one website.

Various embodiments of the present invention are directed to a method of monitoring inventory information associated with at least one container containing an amount of inventory material at a monitored location. In certain embodiments, a method includes receiving in a measurement unit at least one generated data signal representative of the amount of the inventory material in the container, and transmitting the generated data signal to a telemetry unit in communication with the measurement instrument, the telemetry unit being configured to receive at least the generated data signal from the measurement instrument. The method also includes converting the generated data signal into inventory information; transmitting the inventory information through an Internet network connection to at least one server associated with an inventory management location; and serving at least one web page including at least a portion of the inventory information.

Various computer-readable media embodiments provided in accordance with the present invention are also described herein.

### BRIEF DESCRIPTION OF DRAWINGS

Further advantages of the present invention may be understood by referring to the following descriptions taken in conjunction with the accompanying drawings, in which:

FIG. 1 is a schematic diagram of an inventory management system according to various embodiments of the present invention;

FIG. 1A is a schematic diagram of a measurement instrument shown in FIG. 1;

FIG. 2 is a flowchart illustrating a process performed by the inventory management system depicted in FIG. 1 according to various embodiments of the present invention;

FIG. 3 is a schematic drawing of a web page according to various embodiments of the present invention;

FIG. 4 is an example of a web page screen display according to various embodiments of the present invention;

FIG. 5 is an example of a web page screen display according to various embodiments of the present invention;

FIG. 6 is an example of a web page screen display according to various embodiments of the present invention;

FIG. 7 is an example of a web page screen display according to various embodiments of the present invention;

FIG. 8 is an example of a web page screen display according to various embodiments of the present invention;

FIG. 9 is an example of a web page screen display according to various embodiments of the present invention;

FIG. 9A is an example of a web page screen display according to various embodiments of the present invention; and,

FIG. 10 is an example of a web page screen display according to various embodiments of the present invention.

### DESCRIPTION

The term “communication” is used herein generally to refer to any wireless and/or wireline transmission and/or reception of data including, but not limited to, voice, text and video data. In addition, the terms “send,” “transmit” and “receive,” or any conjugations thereof, are used herein generally to refer to data communications over landline and/or wireless technologies including, but not limited to, point-to-point transfers and packet-switched networking.

The term “user” is used herein generally to refer to a person, apparatus, and/or operating system that interfaces and/or communicates with a device or system such as, for example, a person interfacing with an Internet accessible website or a Material Requirements Planning (“MRP”) system accessing and analyzing inventory information in a database and/or on a server.

The term “inventory information” is used herein generally to refer to data including, but not limited to, material identity, container level, inventory amount, inventory temperature, inventory flow rate, specific gravity of the material, moisture content of the material, inventory weight, container specifications, network specifications, user information, usage information, delivery information, monitoring location information and/or other specified parameters.

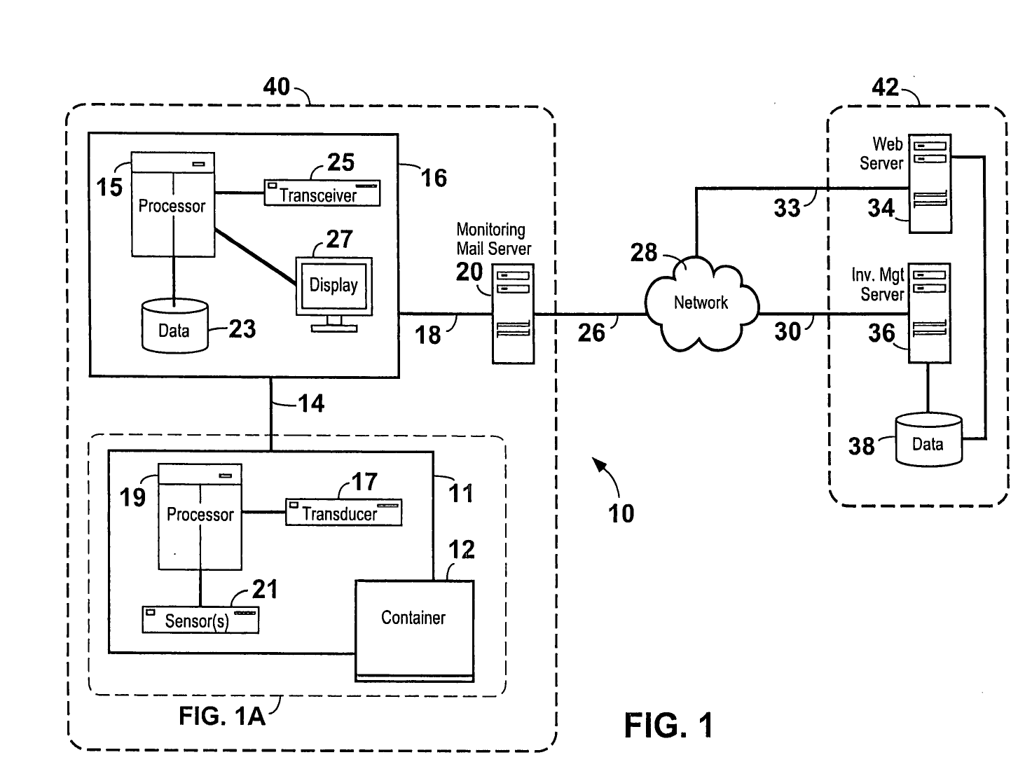

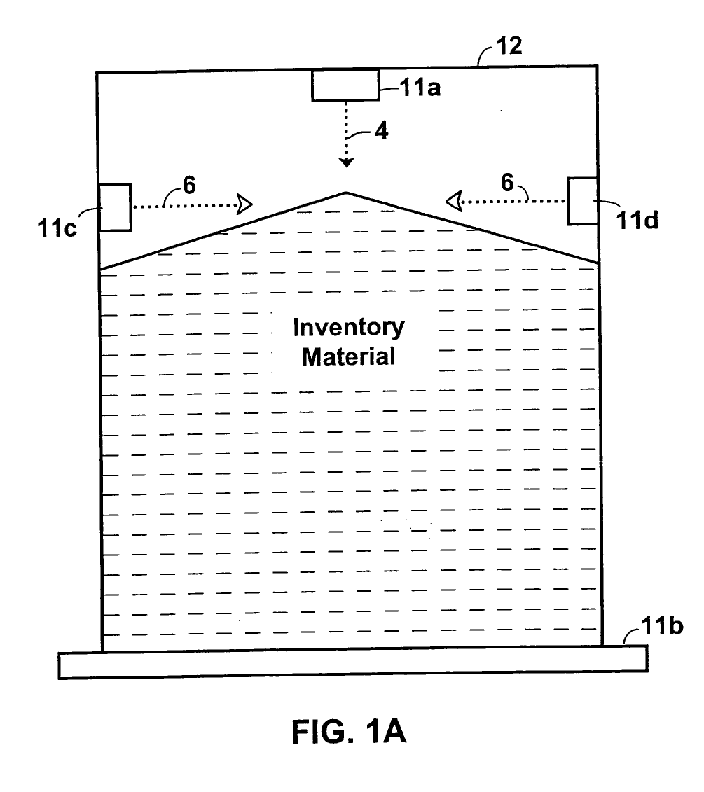

FIG. 1 is a block diagram of an inventory management system 10 structured in accordance with the present invention for monitoring and/or processing data associated with inventory material contained in one or more containers 12 at a monitored location 40. As applied herein, a “container” may include, for example and without limitation, a tank, bin, silo, cargo container, vessel and/or any other storage arrangement that may contain inventory material. According to various embodiments, “inventory material” may include, for example and without limitation, an amount or quantity of gas, liquid, fluid, dry materials, agricultural products (e.g., grain), food products (e.g., cereals), fabricated components (e.g., machined or stamped parts), hardware (e.g., screws, nuts, bolts), raw material and/or other types of physical goods.

In various embodiments of the present invention, the container 12 may be located at a monitored location 40 that comprises, for example and without limitation, a customer workplace, supplier workplace, storage facility, and/or a transportation vehicle, such as an aircraft or watercraft cargo hold, for example. In various aspects, a measurement instrument 11 may be operatively associated with the container 12 such as by attachment to external and/or internal surfaces of the container 12, for example. The measurement instrument 11 may include one or more operative components such as one or more sensors 21, for example, thermocouples, ultrasonic sensors, pressure sensors, sound sensors, radar sensors, strain gages and scales. The measurement instrument 11 may be calibrated to analyze the inventory material held in the container 12 by periodically or non-periodically generating and processing signals representative of the amount of inventory material in the container 12. In certain embodiments, data acquired from analysis of the inventory material may be acquired with a periodic cycle time such as, for example, on an hourly, daily, weekly, monthly or other suitable periodic basis.

A telemetry unit 16 may be operatively associated with the measurement instrument 11 and configured to receive data signals from the measurement instrument 11 representative of the amount of inventory material in the container 12. In various embodiments, the telemetry unit 16 may query the measurement instrument 11 to trigger the measurement instrument 11 to transmit data signals to the telemetry unit 16. The telemetry unit 16 may comprise a processor 15 that converts the transmitted signals into values and descriptions representing inventory information. In addition, the telemetry unit 16 may also store this information in a database 23. According to various embodiments, the measurement instrument 11 may comprise sensors 21 (e.g., temperature sensing elements), ultrasonic transducers 17, and/or other components configured to analyze inventory material in the container 12.

As shown in FIG. 1A and to illustrate the above-mentioned embodiments, the measurement instrument 11 may operate substantially similarly to an ultrasonic level monitor 11 a such as, for example, The Probe™, which is a sensor distributed by Siemens Milltronics®. In one operational example, the measurement instrument 1 la measures a liquid level of an inventory material in the container 12. In this example, the measurement instrument 11 a emits a series of ultrasonic pulses 4 from the transducer 17, wherein each of the pulses 4 is reflected as an echo from the liquid inventory material and sensed by the transducer 17. A processor 19 included within the measurement instrument 11 may be configured to analyze and filter the reflected pulses 4 to discriminate between a true echo reflected from the inventory material and false echoes generated by acoustical and electrical noises. In certain embodiments, the time for the pulses 4 to travel from the measurement instrument 11a to the inventory material and return back to the measurement instrument 11a may be temperature compensated and then converted into value signals capable of being relayed for further processing by other monitoring equipment. After the measurement instrument 11a generates and processes the ultrasonic echo pulses 4, the telemetry unit 16 may query the measurement instrument 11a to trigger the measurement instrument 11a to transmit the value signals to the telemetry unit 16, wherein the telemetry unit 16 may convert the signals into inventory information.

In various embodiments, the measurement instrument 11 may operate substantially similarly to a scale 11b, for example. According to these embodiments, the scale 11b may be utilized to measure an amount of dry inventory material in the container 12. For example, the scale 11b may include an operative association with one or more mechanical springs and/or transducers 17 configured to analyze the weight of the inventory material in the container 12. In one embodiment, the transducers 17 may transmit a data signal representative of the weight of the inventory material to the telemetry unit 16, wherein the telemetry unit may convert the data signal into inventory information.

In certain embodiments, the measurement instrument 11 may also include an operative association with one or more infrared sensors such as sensors 11c, 11d, for example. According to these embodiments, the infrared sensors 11c, 11d may be configured to analyze a defined level associated with the inventory material in the container 12 and transmit a data signal to the telemetry unit 16, wherein the telemetry unit 16 may convert the data signal into inventory information. In one operational example, the defined level may be measured from a bottom portion of the container 12 to a refill location at an elevation higher than the bottom portion of the container 12. In operation, a portion of the inventory material in the vicinity of the refill location interrupts an infrared beam 6 extending from the infrared sensor 11c to resist completion of an electrical circuit, for example, including a connection between the sensors 11c, 11d. Upon depletion of the inventory material from the container 12, the portion of the inventory material in contact with the infrared sensor beam 6 may descend from the refill location toward the bottom portion of the container 12 and become out of contact with the infrared sensor beam 6. It can be seen that sufficient descent of the inventory material may result in the infrared beam 6 completing an electrical circuit between the infrared sensors 11c, 11d that may cause an electrical signal representative of the now depleted level of the inventory material within the container 12 to be communicated to the telemetry unit 16.

In another operational example, the measurement instrument 11 may operate substantially similarly to a PTX 1240™, for example, which is an industrial pressure transmitter suitable for use in the oil and gas industry and distributed by Druck Incorporated™.

In various embodiments, and in accordance with the above-described examples, the measurement instrument 11 may include one or more sensors 21 configured to analyze the composition and/or other attributes of the inventory material. According to these embodiments, the measurement instrument 11 may transmit data signals representing the composition of the inventory material, wherein the transmission of such data is used to preserve the container 12 for use in containing only one type or certain types of inventory material. Such systems and devices may be useful for promoting identity preservation in industries such as, for example, agricultural products, food products, oil, gas, and/or other industries wherein preserving quality requirements, maintaining safety standards, and/or meeting other requirements for avoiding cross-contamination of different kinds of inventory material may be desired.

Referring again to FIG. 1, and to further illustrate various embodiments of the present invention, the telemetry unit 16 may be in data communication with a monitoring mail server 20. The telemetry unit 16 may further comprise a transceiver 25 configured to transmit inventory information and/or other data to the monitoring mail server 20 and/or receive inventory information or other data from the monitoring mail server 20. In addition, the telemetry unit 16 may be equipped with a display 27 that enables a user at the monitored location 40 to view data being monitored and communicated by the inventory management system 10.

In various embodiments, the monitoring mail server 20 may be configured to store data, transmit data and/or receive data through its operative association with the telemetry unit 16 and other servers within the inventory management system 10. The monitoring mail server 20 may also be configured to generate, transmit and receive notifications, wherein the notifications may include, for example and without limitation, (1) delivery notifications that detail a supplier's promise date to deliver material, (2) inventory level notifications that communicate potential material “stock-outs” and/or (3) system alerts that inform customers and suppliers of network outages, measurement instrument loss, hardware/software issues or other system failures.

According to the present embodiments, the telemetry unit 16 may be in communication with the measurement instrument 11 via a wireline and/or wireless communications link 14. In addition, the telemetry unit 16 may also be in communication with the monitoring mail server 20 via a wireline and/or wireless communications link 18. In certain embodiments, the communications links 14 and 18 may be a wireline connection such as, for example, an Ethernet connection or other conventional twisted pair copper wirelines or coaxial cable connection. In various aspects, the communications links 14 and 18 may also be implemented as a wireless connection. Wireless network connectivity between the measurement instrument 11 and the telemetry unit 16 (depicted as communications link 14), and wireless network connectivity between the telemetry unit 16 and the monitoring mail server 20 (depicted as communications link 18), may be accomplished using radio frequencies (RF) such as, for example, IEEE 802.11 wireless LAN or Bluetooth technologies. The IEEE 802.11 standard defines the protocol for two types of networks: ad hoc and client/server networks. An ad hoc network may be a network in which communications are established between multiple stations in a given coverage area without the use of an access point or server. The standard specifies the etiquette that each station must observe so that all stations have fair access to the wireless media. It provides methods for arbitrating requests to use the media to ensure that throughput is maximized for all stations in the base service set. The client/server network uses an access point that controls the allocation of transmit time for all stations and allows mobile stations to roam from cell to cell. The access point is used to handle traffic from the mobile radio to the wired or wireless backbone of the client/server network. This arrangement allows for point coordination of all of the stations in the basic service area and ensures proper handling of the data traffic. The access point also routes data to and from a network server and between wireless stations.

Bluetooth radio technology provides a universal bridge to existing data networks, a peripheral interface, and a mechanism to form small private ad hoc groupings of connected devices away from fixed network infrastructures. Designed to operate in an RF environment, the Bluetooth radio uses fast-acknowledgment and frequency-hopping schemes to make a link between a data network and a peripheral interface. In addition, Bluetooth radio modules may avoid interference from other signals by hopping to a new frequency after transmitting or receiving a data packet.

In various embodiments, the inventory management system 10 may be structured for interaction with a manual data collection system in addition to or in place of an automatic system of gathering inventory information (e.g., the telemetry unit 16 operatively associated with the measurement instrument 11). An operator, for example, may (1) observe the inventory material contained in the container 12, (2) record inventory information and/or other data on paper and/or a spreadsheet, and/or (3) manually input the inventory information and/or other data into the monitoring mail server 20.

According to various embodiments, the monitoring mail server 20 may be in communication with an inventory management server 36 via a network 28 such as, for example, the Internet. In addition, the inventory management server 36 may be located at an inventory management location 42, wherein the inventory management location 42 may include a customer workplace, supplier workplace, storage facility and/or transportation vehicle, aircraft or ship vessel. The servers 20, 36 may provide network addressing and routing, wherein the monitoring mail server 20 functions as a first gateway between the monitoring location 40 and the network 28 and the inventory management server 36 functions as a second gateway between the inventory management location 42 and the network 28. In certain embodiments, the servers 20, 36 may transfer and/or receive data through one or more email systems that are in communication with the network 28 via communications links 26 and 30 respectively, which may be TCP/IP (Transmission Control Protocol/Internet Protocol) connections, for example.

In various embodiments, the server 20, 36 may also be configured to transmit and/or receive inventory information and/or other data via an Advanced Intelligent Network (“AIN”). The inventory information and/or other data may be formatted in a File Transfer Protocol (“FTP”), wherein the FTP may be employed when locations 40, 42 may not be able to access an email system and/or the Internet. In certain embodiments, the inventory management server 36 may be configured to receive data in the form of a Universal Datagram Packet (“UDP”). For example, the UDP may be employed to transfer tank readings internally within a company via a wireless Ethernet connection. In various aspects, the inventory management server 36 may be configured to transmit and receive inventory information and other data to/from the monitored location 40, wherein the monitored location 40 comprises any type of communication equipment such as, for example, a wireless or wireline microcomputer, minicomputer, laptop, personal data assistant (PDA), wireless e-mail device (e.g., BlackBerry), cellular phone, pager, processor, or any other programmable device or computer system configured to transmit and receive data over the network 28.

In certain embodiments, the inventory management server 36 may be configured to transmit data to and/or receive data from the monitoring mail server 20 and other servers operatively associated with the inventory management system 10. The inventory management server 36 may also be configured to generate, transmit and receive notifications, wherein the notifications may include, for example and without limitation, (1) delivery notifications that detail a supplier's promise date to deliver material, (2) inventory level notifications that communicate potential material “stock-outs” and/or (3) system alerts that inform customers and suppliers of network outages, measurement instrument loss, hardware/software issues or other system failures.

In various embodiments, the inventory management server 36 may be configured to extract data from a communication sent from the monitoring mail server 20 and store the data in a database 38, wherein the database 38 is in communication with a web server 34. In certain aspects of the invention, the inventory management server 36 may be operatively associated with the web server 34 in a single server. Once data is extracted and transferred to the database 38, the web server 34 may access and display the data on an Internet website that may be made accessible to users from the monitored location 40, the inventory management location 42, and/or another Internet-accessible location. As a data integrity check, the inventory management server 36 may verify the location of the monitoring mail server 20 by comparing the Internet protocol (“IP”) address of the monitoring mail server 20 against a registry including various monitored locations. If data is transmitted from an IP address that is not registered, the inventory management server 36 can be configured to not accept the data and thus not allow the information to be displayed by the inventory management system 10.

In certain aspects of the present invention, the web server 34 may be configured to transmit data to and/or receive data from the inventory management server 36 and the monitoring mail server 20 via the network 28. The web server 34 may be coupled to the network 28 by a communications link 33, which may be a TCP/IP (Transmission Control Protocol/Internet Protocol) connection, for example. In addition, the web server 34 may also be configured to generate, transmit and/or receive notifications, wherein the notifications may include, for example and without limitation, (1) delivery notifications that detail a supplier's promise date to deliver material, (2) inventory level notifications that communicate potential material “stock-outs” and/or (3) system alerts that inform customers and suppliers of network outages, measurement instrument loss, hardware/software issues or other system failures.

In various embodiments, at least one of the servers 20, 34, 36 may be based on Extensible Markup Language (“XML”), a computer language that encloses data in “documents” that are portable between/among software applications, wherein the data may include inventory information, notifications and/or other data utilized by the inventory management system 10. According to certain embodiments, XML may be utilized as a system-independent language for representing data that is transmitted across the network 28 and between/among the servers 20, 34, 36. This transmission of data may be in the form of simple object access protocol (“SOAP”) messages, which are XML-based messages that are communicated through standard Internet protocols such as, for example, Hypertext Transfer Protocol (“HTTP”) and Simple Mail Transfer Protocol (“SMTP”). In addition, communication of data through the measurement instrument 11, the telemetry unit 16 and/or the servers 20, 34, 36 may, for example, (1) occur at defined cycle times, (2) occur in real time and/or (3) be triggered by a customer and/or a supplier interacting with an Internet-accessible website that is supported by the web server 34.

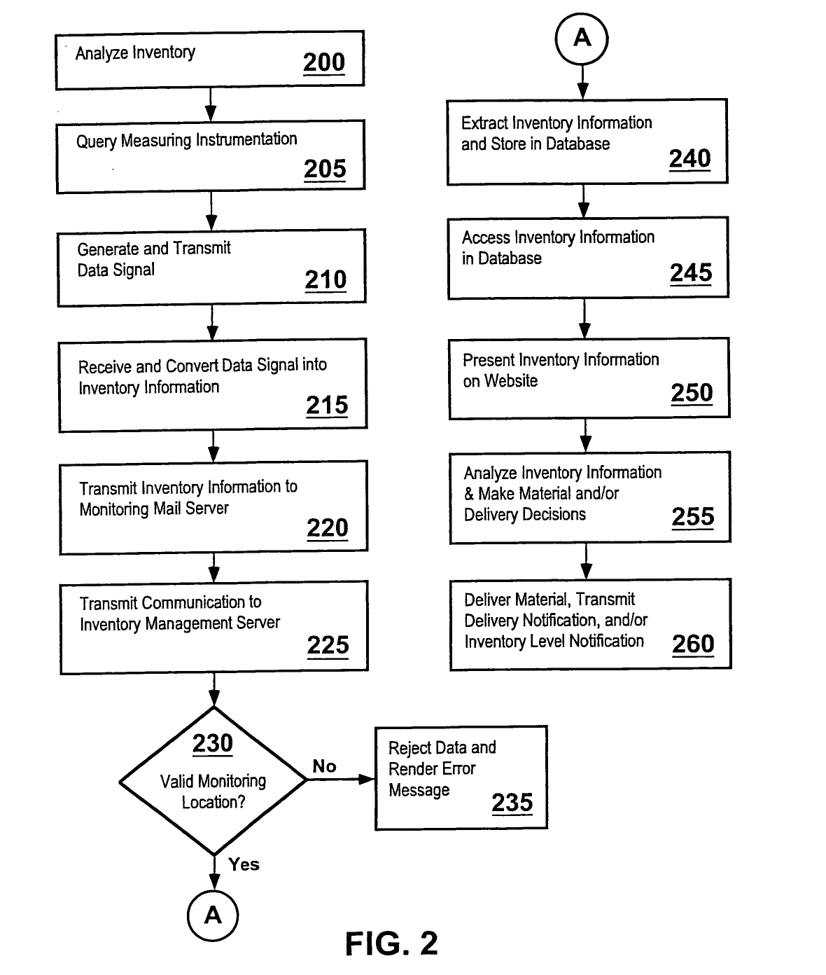

FIG. 2 is a flowchart illustrating embodiments of processes performed by the inventory management system 10 depicted in FIG. 1. At a predetermined time, the measurement instrument 11 analyzes the inventory material held in the container 12 as shown by step 200. In step 205, the telemetry unit 16 queries the measurement instrument 11, and in response to this query, the measurement instrument 11 generates and transmits value data signals to the telemetry unit 16 in step 210. At step 215, the telemetry unit 16 receives and converts the data signals into inventory information. The telemetry unit 16 then proceeds to transmit, at step 220, the inventory information to the monitoring mail server 20, which may be in communication with at least one of the inventory management server 36 and/or the web server 34 via the network 28.

At step 225, the monitoring mail server 20 transmits a communication comprising the inventory information to the inventory management server 36. The inventory management server 36 then determines if the monitoring mail server 20 is associated with a valid monitoring location 40 as shown by step 230. If the monitoring mail server 20 is not associated with a valid monitoring location 40, the inventory management server 36 rejects the data and renders an error message at step 235. However, if the monitoring mail server 20 is associated with a valid monitoring location 40, the inventory management server 36 extracts inventory information from the communication and stores the inventory information in the database 38 as shown by step 240. At step 245, the web server 34 accesses the inventory information in the database 38, and at step 250, presents the inventory information on an Internet-accessible website that is viewable by a user of the inventory management system 10.

The process may then proceed to step 255 where the user such as, for example, an operator and/or an MRP system, may analyze the inventory information and consider a variety of inventory material management decisions. Examples of such management decisions may include, for example, determining whether the quality of the monitored material is acceptable and/or making delivery decisions based on the amount of inventory material contained in the container 12 in relation to a predetermined re-order quantity. In various aspects, the re-order quantity may be based on: (1) the amount of inventory contained in the container 12, (2) the projected/forecasted use of the inventory material, and/or (3) the lead-time required to replenish the inventory. At step 260, in accordance with various operational examples described herein, the user may cause the inventory management system 10 to deliver a shipment of material, transmit a delivery notification that details a supplier's promise date to deliver material and/or transmit an inventory level notification that communicates a potential material “stock-out.”

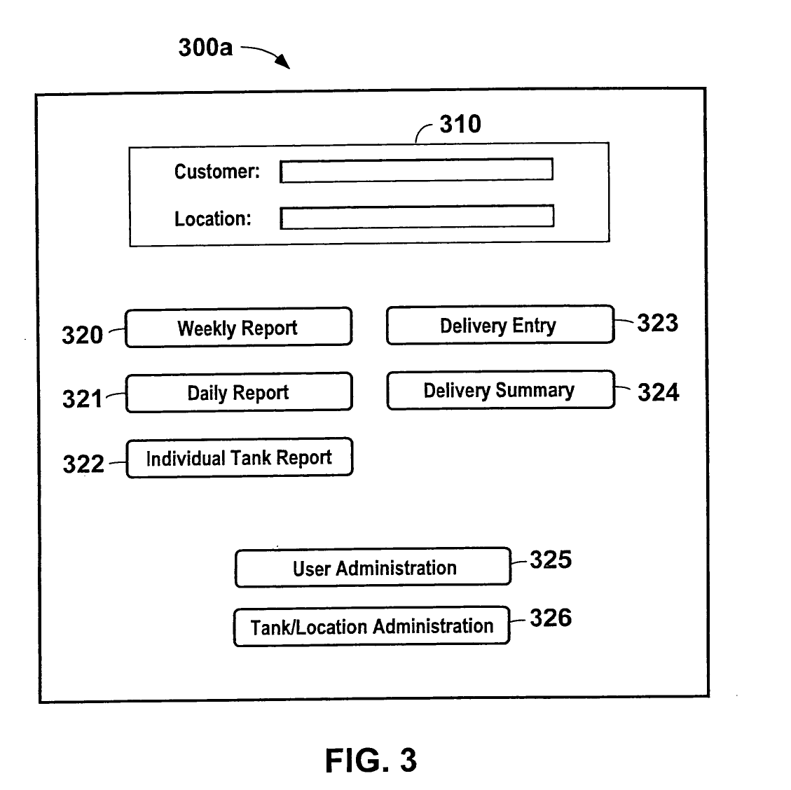

FIG. 3-FIG. 10 illustrate various examples of web page screen displays according to various embodiments of the present invention, wherein the web pages are supported by the web server 34, for example, and may be Internet-accessible such as through the network 28. The web server 34 may support a website that comprises one or more graphical user interfaces (GUIs) configured to receive and display user inputs and data as shown by web pages 300a-300i.

FIG. 3 illustrates a schematic representation of a web page 300a that may function as a main menu screen that enables customers and suppliers, for example, to organize, view and input data regarding the inventory management system 10. In certain embodiments, the web page 300a may allow a user to input customer and monitored location 40 information. The customer and monitored location 40 input may cause the web server 34 to execute a program comprising a set of exclusionary rules that enable or disable data and/or tabs based on the customer and location input.

In various embodiments, the web page 300a may also function as a security screen that requires users of the inventory management system 10 to enter a valid username and password in area 310 of the web page 300a. Entering a username and password may cause the web server 34 to execute a program that compares the username and password entry against a user registry. If the username and password entry are not recorded in the registry, the web server 34 can be configured to not permit a login to occur.

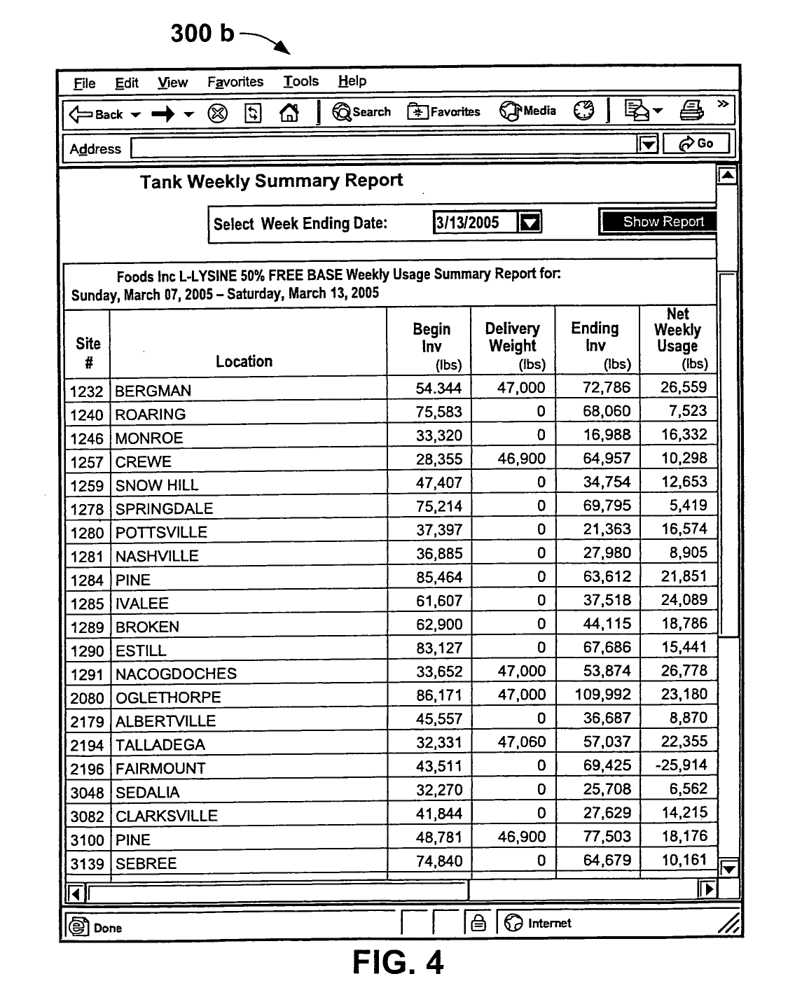

In certain embodiments, the web page 300a may also feature system tabs 320-326, which may be configured to connect from the web page 300a to various secondary web pages that display, for example, weekly reports (320), daily reports (321), individual tank reports (322), delivery entry (323), delivery summary (324), user administration (325) and tank/location administration (326). Each of these system tabs 320-326 and their corresponding secondary web pages are further described hereinbelow with reference to FIG. 4-FIG. 10.

Referring now to FIG. 4, a sample web page 300b that may be served when a user selects the “Weekly Report” tab 320 on the web page 300a shown in FIG. 3. The web page 300b may include a matrix report, wherein the report organizes the weekly usage of a particular product or inventory material according to each monitored location 40 that uses the inventory material and transmits weekly usage information to the web server 34. In various embodiments, the web page 300b may describe the weekly usage of a product per monitored location 40 by including data fields such as, for example, customer description, product description, site number, location description, beginning inventory (in pounds), delivery weight (in pounds), ending inventory (in pounds) and net weekly usage (in pounds). The web page 300b may also be configured to allow the user to input the “Week Ending Date,” for example, which defines a seven (7) day period of product usage that the user desires to view.

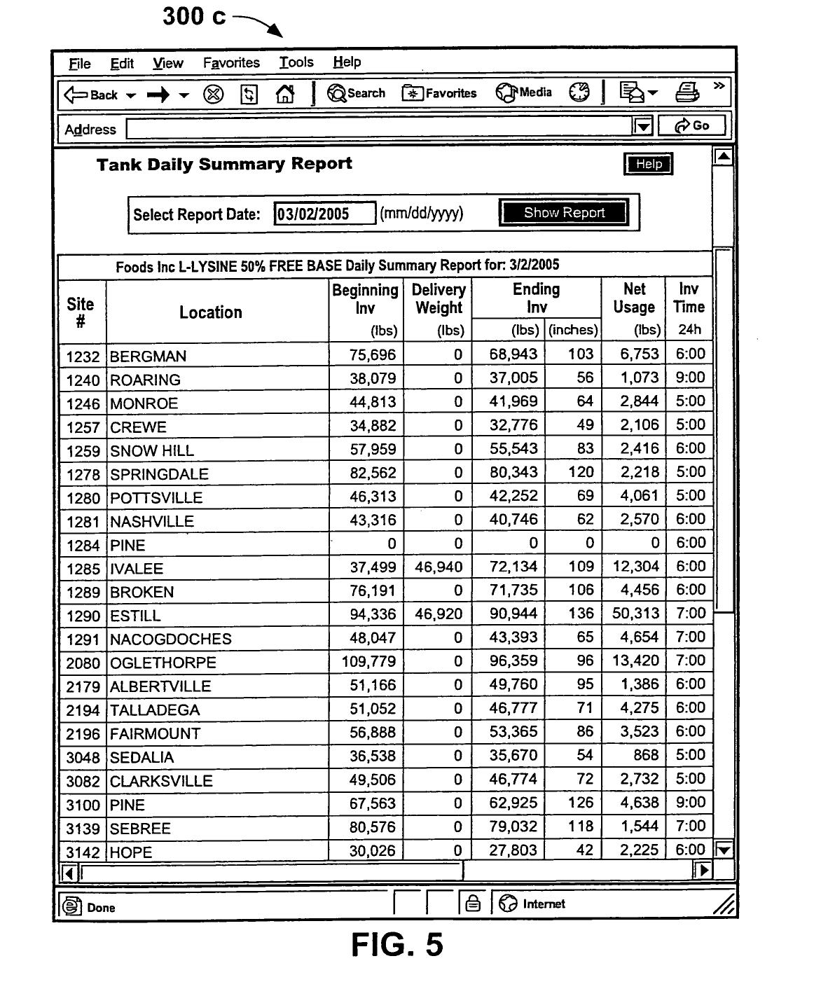

FIG. 5 illustrates an example of a web page 300c, provided in accordance with the present invention, which is served when a user selects the “Daily Report” tab 321 on the web page 300a shown in FIG. 3. In various embodiments, the web page 300c may include a matrix report, wherein the report organizes the daily usage of a particular product or inventory material according to each monitored location 40 that uses the product and transmits daily usage information to the web server 34. In certain embodiments, the web page 300c may describe the daily usage of a product per monitored location 40 by including data fields such as, for example, customer description, product description, site number, location description, beginning inventory (in pounds), delivery weight (in pounds), ending inventory (in pounds and inches), net daily usage (in pounds), and the time of day that the information was recorded. In addition, the web page 300c may also be configured to allow the user to input the “Report Date,” for example, which defines a twenty-four (24) hour period of product usage that the user desires to view.

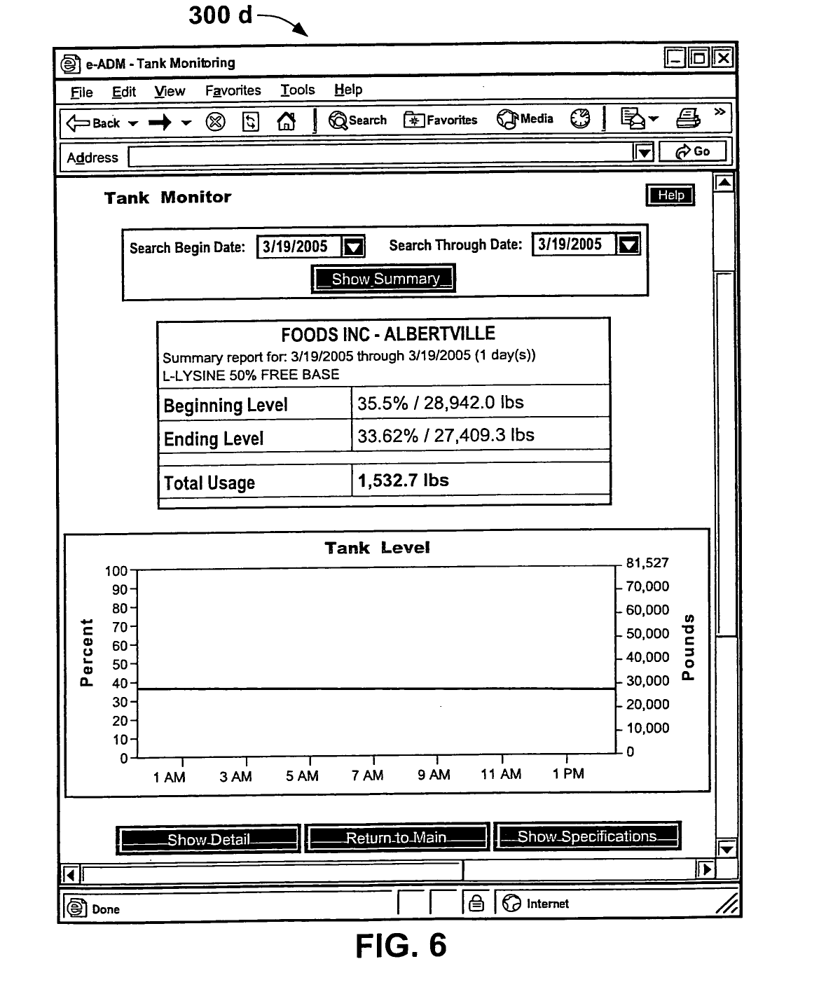

FIG. 6 illustrates an example of a web page 300d, according to embodiments of the present invention, which is served when a user selects the “Individual Tank Report” tab 322 on web page 300a shown in FIG. 3. The web page 300d may describe the usage of a particular product or inventory material in relation to each container 12 that holds the product (e.g., tank level). For example, the web page 300c may be configured to allow the user to input a “Search Begin Date” and/or a “Search Through Date, ” which dates define a time period of product usage that the user desires to view. The web page 300d may also feature a graph that enables the user to quickly reference the “tank level” of a product over the user-defined time period. In certain embodiments, the web page 300d may also describe the product inventory level by displaying one or more of the following data fields: customer description, product description, site number, location description, beginning inventory (e.g., in pounds and in tank level percentage), delivery weight (e.g., in pounds and in tank level percentage), ending inventory (e.g., in pounds and in tank level percentage) and total usage (e.g., in pounds). The web page 300d may also include tabs that enable the user to access more detailed information concerning the container 12 and/or product inventory.

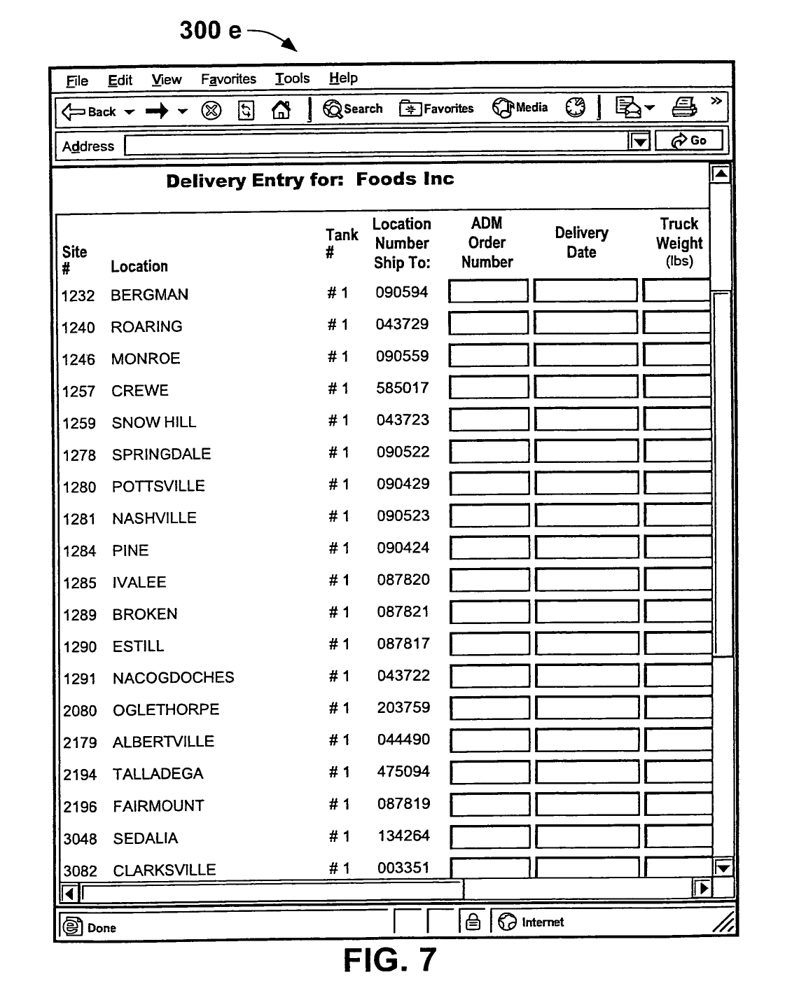

Referring now to FIG. 7, an example of a web page 300e in accordance with the present invention is shown. The web page 300e is served when a user selects the “Deliver Entry” tab 323 on the web page 300a shown in FIG. 3. In various embodiments, the web page 300e may enable the supplier to enter, edit and/or delete product delivery schedules for inventory material at one or more monitored locations 40. The web page 300e may enable a user to update a delivery schedule by displaying, for example, one or more of the following data fields: customer description, product description, site number, location description, tank number, location number to ship to, order number, delivery date and truck weight (in pounds). The web page 300e may be configured to accept updates to the product delivery schedule, wherein the updates are entered automatically by a supplier's order replenishment system. In certain embodiments, the web page 300e may alternatively be configured to accept updates to the product delivery schedule, wherein the updates are manually entered by users. Updates to a delivery schedule on the web page 300e may cause the web server 34 and/or the inventory management server 36 to e-mail, for example, a delivery notification to the monitoring mail server 20, thus informing the customer associated with the monitored location 40, for example, of an upcoming, modified and/or cancelled material shipment.

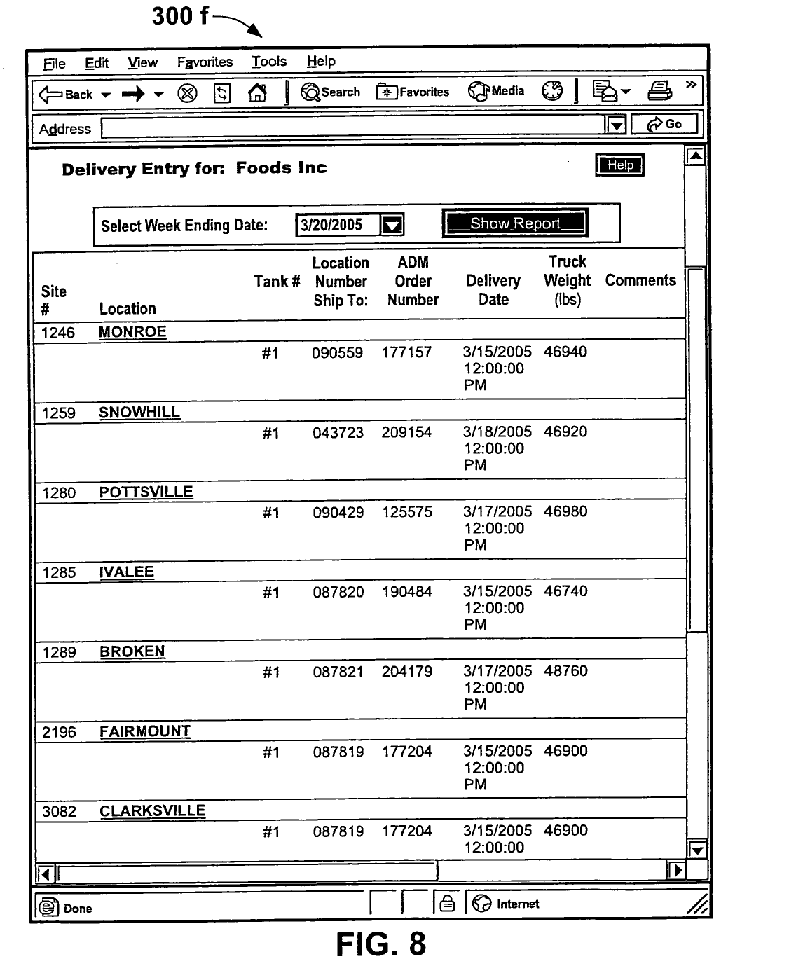

FIG. 8 illustrates an example web page 300f structured in accordance with various embodiments of the present invention. The web page 300f is served when a user selects the “Delivery Summary” tab 324 on web page 300a shown in FIG. 3. In various embodiments, the web page 300f may be configured to allow a user to input the “Week Ending Date,” for example, which defines a seven (7) day period of delivery schedules that the user desires to view. The web page 300f may include a report that displays a weekly list of shipments for a particular product or inventory material, wherein the shipments are designated to arrive at one or more monitored locations 40 within the user-defined time period. In certain embodiments, the web page 300f may also describe the scheduled weekly shipments of a product per monitored location 40 by including data fields such as, for example, customer description, product description, site number, location description, tank number, location number to ship to, order number, delivery date, truck weight (in pounds) and comments.

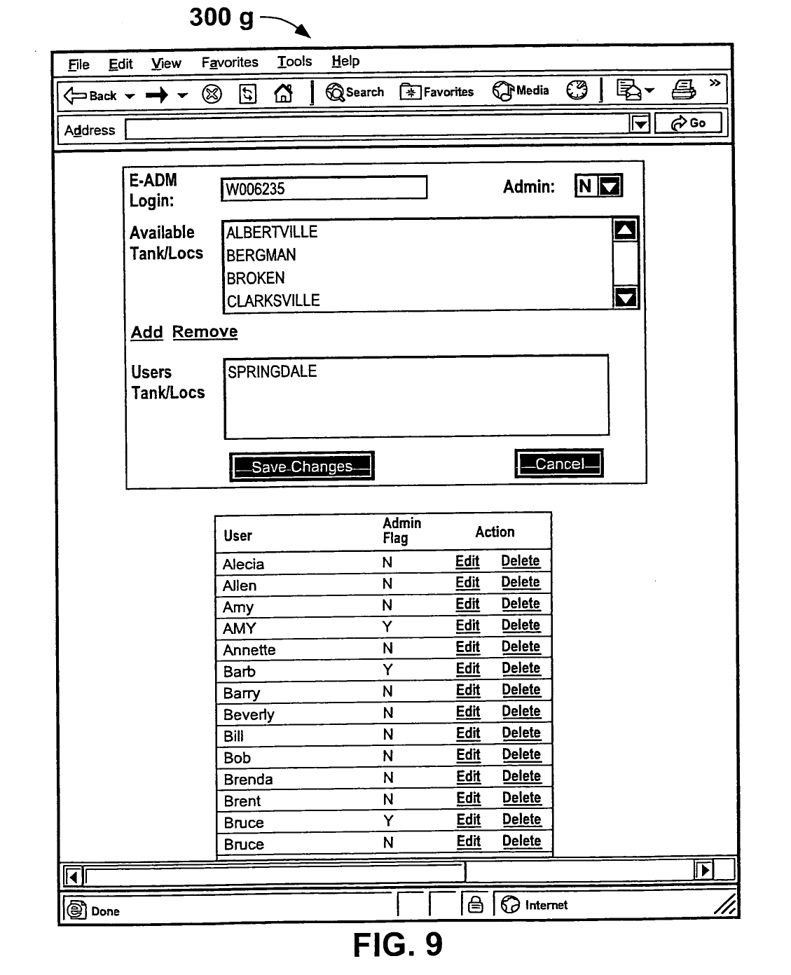

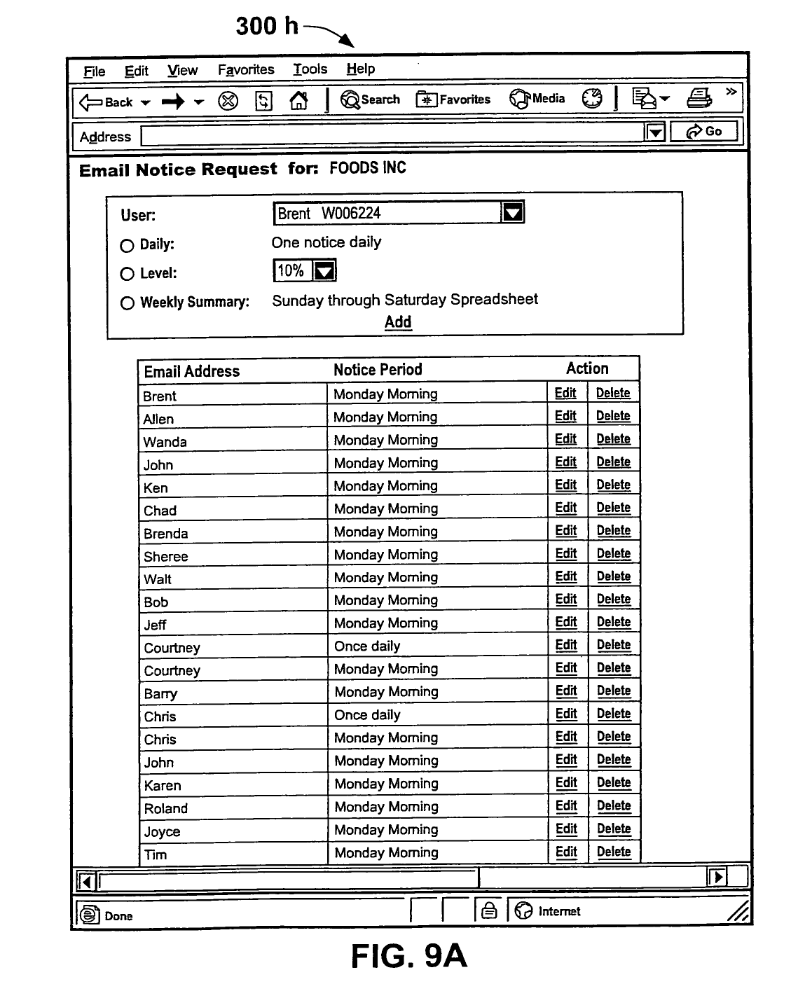

FIG. 9 illustrates an example web page 300g, according to various embodiments of the present invention, that is served when a user selects the “User Administration” tab 325 on web page 300a shown in FIG. 3. For security purposes, the web page 300g may feature a login screen that enables an authorized system administrator, for example, to access and write to administrative data fields. The data fields may control a user's permission to access information associated with specified locations 40, 42 and/or containers 12. In addition, the data fields may control a user's permission to view and/or write to system tabs 320-326 featured on web page 300a shown in FIG. 3. In certain embodiments, the web page 300g may include a listing of system users that identifies each user and the features of the inventory management system 10 that each user has permission to access. The listing may include, for example, a user name, an “admin” flag and/or an action feature that enables the system administrator to add, delete and/or edit the security status of various listed users.

FIG. 9A illustrates an example of a further web page 300h, according to the present embodiments, that is served when a user selects the “User Administration” tab 325 on web page 300a shown in FIG. 3. The web page 300h may, for example, enable a system administrator to assign a user the permission to receive weekly reports, daily reports, and/or email notifications as defined hereinabove with reference to FIGS. 4, 5 and 7. In various embodiments, the web page 300h may also include a listing of system users that identifies each user and defines the frequency with which each user is to receive reports and/or notifications. The listing may include, for example, the user name, e-mail address, notice period and/or an action feature that enables the system administrator to add, delete and/or edit the notice request status of the listed user.

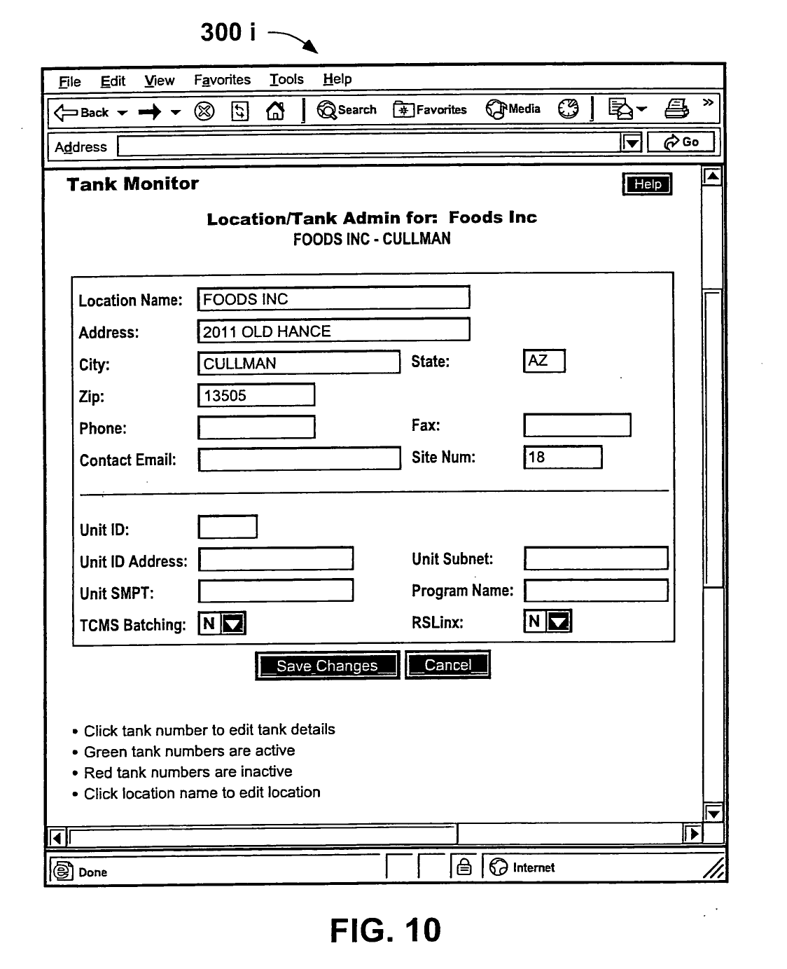

Referring now to FIG. 10, a sample web page 300i is structured in accordance with various embodiments of the present invention. The web page 300i is served when a user selects the “Tank/Location Administration” tab 326 on the web page 300a shown in FIG. 3. The web page 300i may enable a system administrator, for example, to update the inventory management system 10 by adding, deleting and/or updating a monitored location 40 and/or a container 12. In various embodiments, the web page 300i may include, for example, location data fields that enable a system administrator to enter location name, location address, location contact information, network settings, network address information and batching systems information for the monitored location 40. The web page 300i may also include one or more container 12 data fields that enable the system administrator to enter container dimensions, container location, sensor settings, telemetry settings and inventory information.

It is to be understood that the figures and descriptions of the present invention have been simplified to illustrate elements that are relevant for a clear understanding of the present invention, while eliminating, for purposes of clarity, other elements of a conventional inventory management system. For example, certain inventory operating system details and modules of network platforms are not described herein. Those of ordinary skill in the art will recognize, however, that these and other elements may be desirable in a typical inventory management system. However, because such elements are well known in the art and because they do not facilitate a better understanding of the present invention, a discussion of such elements is not provided herein.

Also, in the claims appended hereto, any element expressed as a means for performing a specified function is to encompass any way of performing that function including, for example, a combination of elements that perform that function. Furthermore the invention, as defined by such means-plus-function claims, resides in the fact that the functionalities provided by the various recited means are combined and brought together in a manner as defined by the appended claims. Therefore, any means that can provide such functionalities may be considered equivalents to the means shown herein.

In general, it will be apparent to one of ordinary skill in the art that some of the embodiments as described hereinabove may be implemented in many different embodiments of software, firmware, and hardware in the entities illustrated in the figures. The actual software code or specialized control hardware used to implement some of the present embodiments is not limiting of the present invention. For example, the embodiments described hereinabove may be implemented in computer software using any suitable computer software language type such as, for example, C or C++ using, for example, conventional or object-oriented techniques. Such software may be stored on any type of suitable computer-readable medium or media such as, for example, a magnetic or optical storage medium. Thus, the operation and behavior of the embodiments are described without specific reference to the actual software code or specialized hardware components. The absence of such specific references is feasible because it is clearly understood that artisans of ordinary skill would be able to design software and control hardware to implement the embodiments of the present invention based on the description herein with only a reasonable effort and without undue experimentation.

Moreover, the processes associated with the present embodiments may be executed by programmable equipment, such as computers. Software that may cause programmable equipment to execute the processes may be stored in any storage device, such as, for example, a computer system (non-volatile) memory, an optical disk, magnetic tape, or magnetic disk. Furthermore, some of the processes may be programmed when the computer system is manufactured or via a computer-readable medium. Such a medium may include any of the forms listed above with respect to storage devices and may further include, for example, a carrier wave modulated, or otherwise manipulated, to convey instructions that may be read, demodulated/decoded and executed by a computer.

It can also be appreciated that some process aspects described herein may be performed using instructions stored on a computer-readable medium or media that direct a computer system to perform the process aspects. A computer-readable medium may include, for example, memory devices such as diskettes, compact discs of both read-only and read/write varieties, optical disk drives, and hard disk drives. A computer-readable medium may also include memory storage that may be physical, virtual, permanent, temporary, semi-permanent and/or semi-temporary. A computer-readable medium may further include one or more data signals transmitted on one or more carrier waves.

A “computer” or “computer system” may be, for example, a wireless or wireline variety of a microcomputer, minicomputer, laptop, personal data assistant (PDA), wireless e-mail device (e.g., BlackBerry), cellular phone, pager, processor, or any other programmable device configured to transmit and receive data over a network. Computer devices disclosed herein may include memory for storing certain software applications used in obtaining, processing and communicating data. It can be appreciated that such memory may be internal or external to the disclosed embodiments. The memory may also include any means for storing software, including a hard disk, an optical disk, floppy disk, ROM (read only memory), RAM (random access memory), PROM (programmable ROM), EEPROM (electrically erasable PROM), and other computer-readable media.

While several embodiments of the invention have been described, it should be apparent, however, that various modifications, alterations and adaptations to those embodiments may occur to persons skilled in the art with the attainment of some or all of the advantages of the present invention. For example, in some embodiments of the present invention disclosed herein, a single component may be replaced by multiple components, and multiple components may be replaced by a single component, to perform a given function or functions. Except where such substitution would not be operative to practice embodiments of the present invention, such substitution is within the scope of the present invention. The disclosed embodiments are therefore intended to include all such modifications, alterations and adaptations without departing from the scope and spirit of the present invention as defined by the appended claims.

1. An inventory management system configured for use in association with at least one container containing an amount of inventory material at a monitored location, the system comprising:
at least one measurement instrument operatively associated with the container, the measurement instrument being configured to generate at least one data signal representative of the amount of the inventory material in the container;
a telemetry unit in communication with the measurement instrument, the telemetry unit being configured to receive at least the generated data signal from the measurement instrument and to convert the generated data signal into inventory information;
a first server in communication with the telemetry unit, the first server configured to receive at least the inventory information from the telemetry unit; and
at least a second server in communication with the first server, the second server configured for receiving at least the inventory information from the first server via an Internet connection, the second server being configured to process the inventory information for presentation on at least one website.

2. The system of claim 1, wherein at least one of the measurement instrument, the telemetry unit, and the first server are located at the monitored location.

3. The system of claim 1, wherein the second server is located at an inventory management location.

4. The system of claim 1, wherein the container comprises at least one of a tank, bin, silo, vessel and storage arrangement.

5. The system of claim 1, wherein the inventory material comprises at least one of a gas, liquid, agricultural product, food product, fabricated component, hardware, raw material and physical good.

6. The system of claim 1, wherein the measurement instrument comprises at least one of a thermocouple, ultrasonic sensor, pressure sensor, sound sensor, and radar sensor.

7. The system of claim 1, further comprising a communications link between the measurement instrument and the telemetry unit, wherein the communications link comprises at least one of a wireline communications link and a wireless communications link.

8. The system of claim 7, wherein the wireline communications link comprises an Ethernet connection.

9. The system of claim 7, wherein the wireless communication link comprises at least one of a radio frequency, IEEE 802.11 wireless LAN and Bluetooth technology.

10. The system of claim 1, further comprising a communications link between the telemetry unit and the first server, wherein the communications link comprises at least one of a wireline communications link and wireless communications link.

11. The system of claim 10, wherein the wireline communications link comprises an Ethernet connection.

12. The system of claim 10, wherein the wireless communication link comprises at least one of a radio frequency, IEEE 802.11 wireless LAN and Bluetooth technology.

13. The system of claim 1, wherein the inventory information comprises at least one of material identity, container level, inventory amount, inventory temperature, inventory flow rate, specific gravity, moisture content, weight, container specifications, network specifications, usage information, delivery information, user information and workplace information.

14. The system of claim 1, wherein the website comprises at least one web page including at least one of a main menu, a weekly report, a daily report, an individual container report, a delivery entry, a delivery summary, a user administration menu and a container/location administration menu.

15. The system of claim 1, further comprising at least one of the servers being configured to process at least one of at least one message and at least one notification.

16. The system of claim 15, wherein the at least one notification comprises at least one of a delivery notification, an inventory level notification and a system alert.

17. The system of claim 15, wherein at least one of the message and the notification comprises an Extensible Markup Language (XML) message including the inventory information.

18. The system of claim 15, wherein at least one of the message and the notification comprises a Simple Object Access Protocol (SOAP) message including the inventory information.

19. A method of monitoring inventory information associated with at least one container containing an amount of inventory material at a monitored location, the method comprising:
receiving in a measurement unit at least one generated data signal representative of the amount of the inventory material in the container;
transmitting the generated data signal to a telemetry unit in communication with the measurement instrument, the telemetry unit being configured to receive at least the generated data signal from the measurement instrument;
converting the generated data signal into inventory information;
transmitting the inventory information through an Internet network connection to at least one server associated with a inventory management location; and
serving at least one web page including at least a portion of the inventory information.

20. A computer-readable medium including instructions for performing a method of monitoring inventory information associated with at least one container containing an amount of inventory material at a monitored location, the computer-readable medium comprising:
instructions for receiving in a measurement unit at least one generated data signal representative of the amount of the inventory material in the container;
instructions for transmitting the generated data signal to a telemetry unit in communication with the measurement instrument, the telemetry unit being configured to receive at least the generated data signal from the measurement instrument;
instructions for converting the generated data signal into inventory information;
instructions for transmitting the inventory information through an Internet network connection to at least one server associated with a inventory management location; and
instructions for serving at least one web page including at least a portion of the inventory information.

21. An inventory management system configured for use in association with at least one container containing an amount of inventory material at a monitored location, the system comprising:
at least a first server in communication with the monitored location, the first server configured for receiving at least inventory information from the monitored location via an Internet connection, the first server being configured to process the inventory information for presentation on at least one website; and,
wherein the inventory information includes generated data representative of the amount of the inventory material in the container.
